(19) United States
(12) Patent Application Publication
(10) Pub. No.: US 2015/0213523 A1
(43) Pub. Date: Jul. 30, 2015

(54) COMMUNITY COMMERCE FUNDRAISING SYSTEM AND METHOD

(71) Applicant: NDP Group, LLC, Joliet, IL (US)

(72) Inventors: Dean Alan Tomich, Joliet, IL (US); Gary Leroy Wright, St. Charles, IL (US); Lawrence John Ross, Naperville, IL (US)

(21) Appl. No.: 14/605,703

(22) Filed: Jan. 26, 2015

Related U.S. Application Data
(60) Provisional application No. 61/931,340, filed on Jan. 24, 2014.

(51) Int. Cl. G06Q 30/06; G06Q 40/00

(52) U.S. Cl. CPC G06Q 30/0601; G06Q 40/00

(57) ABSTRACT

A community commerce system and method is centered about a common website and electronically generated gift cards, or e-gift cards. The system and method encourages what is referred to herein as “community commerce” among several classes of participants, including: i) merchants/business owners; ii) shoppers; and iii) charities/nonprofits/fundraisers. A member may use the website to purchase electronic e-gift cards, redeemable at a merchant's place of business. Each e-gift card is associated with an individual merchant, has a face value, and further has an identified quantity of donation dollars. Each merchant establishes their own e-gift card, determining both the face value of each e-gift card and how many donation dollars are to be given to shoppers in exchange for each e-gift card purchase.

### CROSS-REFERENCE TO RELATED APPLICATIONS

This application claims the benefit of U.S. provisional patent application No. 61/931,340, filed Jan. 24, 2014, the entirety of which is hereby incorporated by reference.

### BACKGROUND OF THE INVENTION

1. Field of the Invention

The present invention relates, in general, to charitable and nonprofit fundraising, and, in particular, to a community commerce system and method that is centered about a common website and electronically generated gift cards, or e-gift cards.

2. General Background of the Invention

Charitable fundraising that employs scrips, or gift cards, is well known. In a typical known use of gift cards by a charity or nonprofit organization, a relatively large quantity of physical gift cards are purchased in bulk by the fundraising organization. Each of the gift cards has a face value and is typically associated with an individual merchant or vendor, and is sold to the organization at a discount (i.e., an amount less than the face value at which the gift card is redeemable at the merchant for goods or services). Supporters of the fundraising organization purchase the gift card at face value, with the difference between the face value and initial purchase price being kept by the fundraising organization for its purposes.

### SUMMARY OF THE INVENTION

The present invention presents a community commerce system and method that is centered about a common website and electronically generated gift cards, or e-gift cards. The system and method encourages what is referred to herein as “community commerce” among several classes of participants, including: i) merchants/business owners; ii) shoppers; and iii) charities/nonprofits/fundraisers. The central website functions as a community portal, linking these three classes of participants.

A member shopper may use the website to purchase electronic e-gift cards, that are redeemable at a member merchant's place of business. The member shopper can use the website to search for a particular local or national merchant. Each e-gift card is associated with an individual merchant, has a face value (i.e., the amount redeemable with the merchant for goods or services), and further has an identified quantity of what is referred to herein as “donation dollars”—i.e., an amount of funds, that, in exchange for purchase of the e-gift card, will be supplied by the merchant to the shopper, to be kept on account by the operator of the website on behalf of the shopper for donation to one or more charities/nonprofits/fundraisers designated by the shopper, all facilitated by the present community commerce fundraising website.

A search engine enables member shoppers to search for merchants' businesses in a variety of manners, including local versus national businesses, or by category of products or services provided. Each merchant may join the website for a flat setup fee, and is then given a custom webpage to promote their e-gift card, and to provide user with store and brand information. Each merchant establishes their own e-gift card, determining both the face value of each e-gift card and how many donation dollars are to be given by the merchant to shoppers in exchange for each e-gift card purchase.

Each e-gift card is accessible at a merchant's place of business via a printed document having a two-dimensional barcode displayed thereon, via a smartphone or tablet displaying the 2-D barcode, or via manual entry of a unique alphanumeric redemption code assigned to the e-gift card. The printed barcode, virtual barcode, or redemption code may be used when purchasing goods or services from the associated merchant. The unique alphanumeric redemption code may also be entered by a shopper owning the particular e-gift card when making purchases from member merchants' online stores. As e-gift cards are used at associated merchants' places of business or online, purchases result in commensurate debits being applied to the tracked value of the associated e-gift card. Each user is provided with a virtual wallet of purchased e-gift cards, enabling them to view their purchase history, redeem active cards, and make additional purchases of fully redeemed e-gift cards.

Charities, nonprofits and other individuals/entities may start a fundraiser on the website by creating an account, describing themselves (using text, photos and videos), and identifying a personal or organizational goal, which is then posted to the website. The charities/nonprofits can then encourage their supporters to purchase e-gift cards of their choice, from any available merchant, and to direct their associated donation dollars received from the merchant in exchange for e-gift card purchases to their particular fundraiser. Fundraisers may, for an additional fee or otherwise, become featured fundraisers towards receiving more donation dollars from various shoppers.

### BRIEF DESCRIPTION OF THE SEVERAL VIEWS OF THE DRAWINGS

FIG. 1 is a simplified block diagram showing the interconnectivity of the servers and terminals employed in the operation, access, and use of the community commerce fundraising website;

FIG. 2 is a depiction of a home page of a community commerce fundraising website in an embodiment of the present invention;

FIG. 3 is a depiction of an e-gift card shopping page of the community commerce fundraising website;

FIG. 4 is a depiction of an e-gift card detail page of the community commerce fundraising website;

FIG. 5 is a depiction of a donate/fundraiser search page of the community commerce fundraising website;

FIG. 6 is a depiction of a fundraiser detail page of the community commerce fundraising website;

FIG. 7 is a depiction of a new fundraiser project creation page of the community commerce fundraising website;

FIG. 8 is a depiction of the e-gift card page of a user's virtual wallet of the community commerce fundraising website;

FIG. 9 is a depiction of an e-gift card redemption page of a user's virtual wallet of the community commerce fundraising website;

FIG. 10 is a depiction of a user's funded fundraisers page of the community commerce fundraising website;

FIG. 11 is a depiction of a user's personal fundraisers page of the community commerce fundraising website;

FIG. 12 is a depiction of an edit fundraiser page of the community commerce fundraising website;

FIG. 13 is a depiction of a list of funders associated with an individual fundraiser page of the community commerce fundraising website;

FIG. 14 is a depiction of a user profile edit page of the community commerce fundraising website;

FIG. 15 is a depiction of a view shopping cart page of the community commerce fundraising website;

FIG. 16 is a depiction of a merchant portal transaction page of the community commerce fundraising website;

FIG. 17 is a depiction of a first project funding popup dialog of the community commerce fundraising website; and

FIG. 18 is a depiction of a second project funding popup dialog of the community commerce fundraising website.

### DETAILED DESCRIPTION OF THE INVENTION

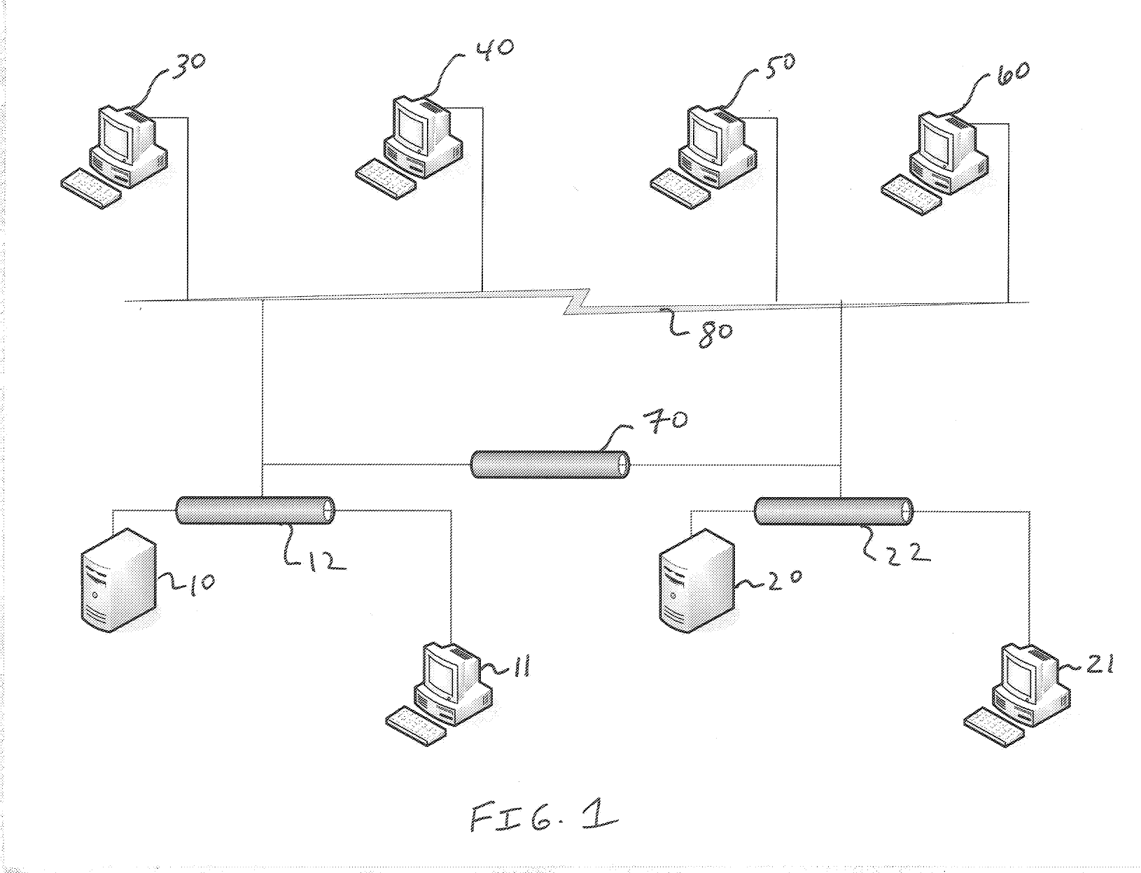

A simplified block diagram showing the interconnectivity of the servers and terminals employed in the operation, access, and use of the present community commerce fundraising website is shown in FIG. 1 as comprising web server 10, e-commerce server 20, shopper terminal 30, fundraiser terminal 40, merchant terminal 50, and point-of-sale terminal 60. Web server 10 serves to generally operate the community commerce website, receiving hypertext transfer protocol (HTTP) requests via a global network, such as internet 80, and serving hypertext markup language (HTML) and other content in response, to/from terminals 30, 40, 50 and 60. Servers 10 and 20 may comprise personal computers, minicomputers or mainframes. Terminals 30, 40 and 50 may comprise desktop and laptop personal computers, tablet and other handled computers, smartphones, or any combination of the foregoing. For brick-and-mortar stores, point-of-sale terminal 60 may comprise a personal computer-based cash register system or the like, including, for example, an associated barcode scanner, cash drawer, LED pole display and receipt printer. For online stores, point-of-sale terminal 60 may instead comprise an e-commerce server associated with an individual merchant.

Web server 10 may include an associated database server for storing information relating to users, merchants, fundraisers, and e-gift cards or, alternatively, one or more external database servers may be coupled to web server 10. Moreover, web server 10 may alternatively be a plurality of servers, rather than a single server, organized in what is known as a web farm. Local area network 12 couples web server 10 to one or more internal maintenance terminals 11 for support and maintenance operations.

E-commerce server 20 facilitates transactions involving e-gift cards at individual member merchant stores, which may be either traditional brick-and-mortar stores or online stores. E-commerce server 20 also acts as a gateway for credit card transactions, and for payment processing via PayPal and other online payment and money transfer service providers. For example, when a shopper purchases an e-gift card, a payment is made from the associated merchant, to be kept on behalf of the purchaser in the form of donation dollars. As another example, when a shopper directs a quantity of donation dollars to a particular fundraiser, a corresponding monetary amount is transferred to the organization associated with the fundraiser. E-commerce server 20 may include an associated database server or, alternatively, one or more external database servers may be coupled to e-commerce server 20. Moreover, e-commerce server 20 may alternatively be a plurality of servers, rather than a single server, organized in an e-commerce server farm. Local area network 22 couples e-commerce server 20 to one or more internal maintenance terminals 22 for support and maintenance operations.

Web server 10 and e-commerce server 20 may optionally be coupled by a high speed dedicated data link or wide-area network 70, rather than internet 80, for enhanced speed and security of the back-and-forth communications between the servers.

A web browser running on shopper terminal 30 may be used by an individual in conjunction with web server 10 to, among other things join, or become a member of the present community commerce fundraising website, to search for, purchase and print e-gift cards, to view a pool of funds accumulated from the purchase of various e-gift cards, referred to herein as “donation dollars”, and to donate all or a portion of the shopper's donation dollars to one or more established fundraisers. A web browser or a dedicated application running on fundraiser terminal 40 may be used by an individual in his/her individual capacity, but more typically on behalf of a nonprofit organization, a school, a youth sports team, community organizations, a church, a charity, or other entity in conjunction with web server 10 to, among other things join, or become a member of the present community commerce fundraising website, to create and establish a new fundraiser within the community commerce website, and to monitor the progress of their fundraisers. A web browser or a dedicated application running on merchant terminal 50 may be used by an individual in his/her individual capacity, but more typically on behalf of a for-profit business entity to, among other things join, or become a member of the present community commerce fundraising website, to promote their businesses, and to create prospective e-gift cards to be acquired by shoppers in exchange for the merchant user's provision of donation dollars to the shopper.

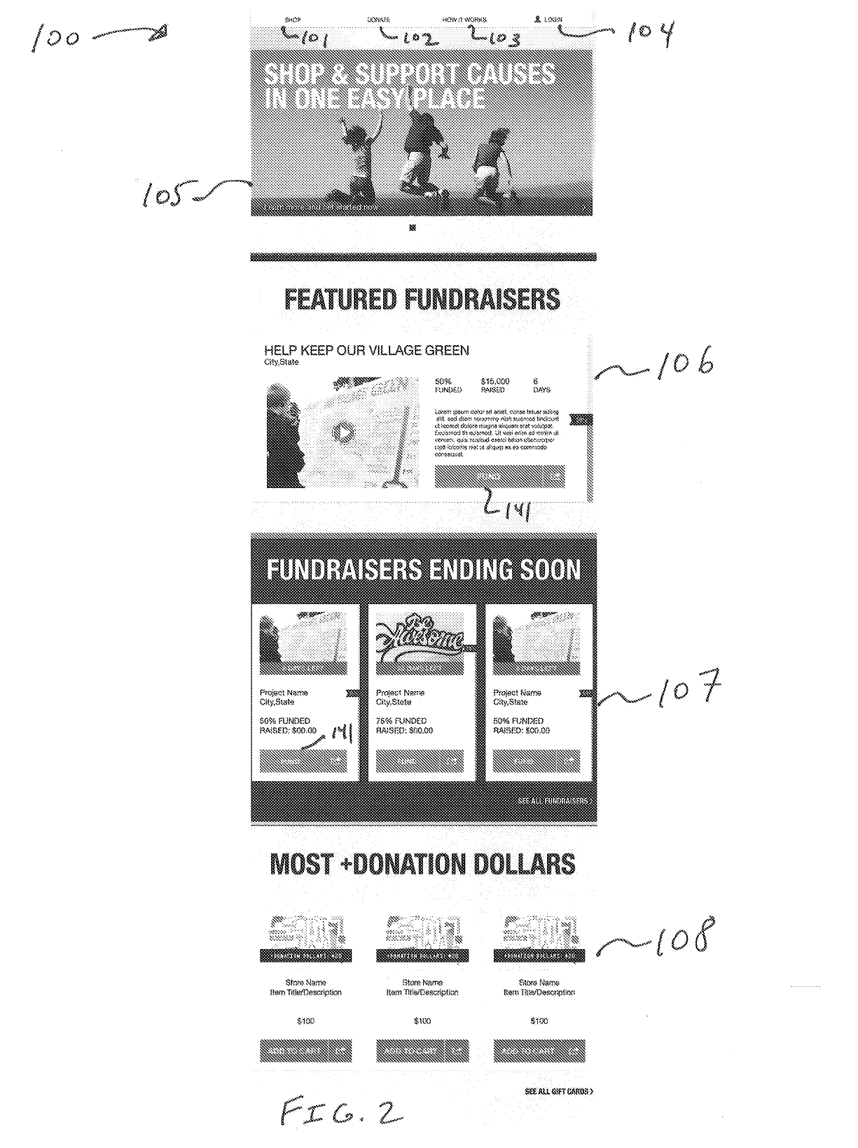

While FIGS. 2-18 depict individual web pages and popup dialog pages of a community commerce website embodiment of the present invention which may be rendered as web pages within a web browser running on a personal computer, tablet, or smartphone, a dedicated application, or “app”, may alternatively be employed, particularly on tablets and smartphones, to achieve similar functionality. Referring to FIG. 2, home page 100 of the community commerce and fundraising website is shown as comprising shop button 101, donate button 102, how it works button 103, login button 104, rotating banner region 105, featured fundraisers region 106, fundraisers ending soon region 107, and most donation dollars button 108. Although not shown in FIG. 2, home page 100 may further comprise an e-commerce shopping cart icon, and links to the website's associated privacy policy, terms and conditions of use, and Facebook, Twitter, and other social media pages and feeds.

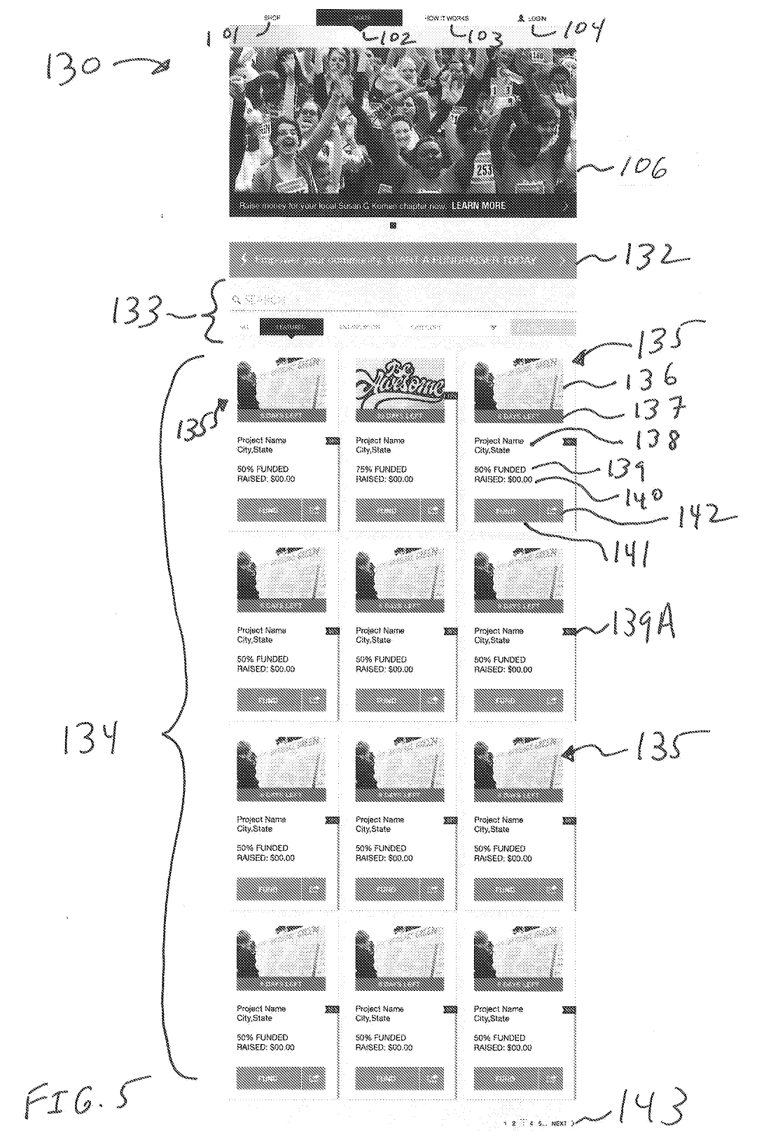

While certain specific text is shown in the various webpage buttons of the figures, it should be noted that alternative text may instead be used. For example, “fund” button 141 of FIG. 5 may instead use the text “donate” to connote a similar function. Moreover, as is known in the art, text associated with the various controls and information paragraphs may be retrieved from a database as each web page is rendered to, for example, permit alternative language versions of the community commerce website, such as Spanish, to alternatively be presented to users.

Clicking a mouse or other pointing device on, positioning a cursor over, or otherwise selecting login button 104 causes a drop-down menu to appear below login button 104. The drop-down menu enables established users to enter their username and password, and to then sign into the system. The drop-down menu also includes a link facilitating the handling of a forgotten username or password, and another link enabling prospective users to establish an account and to thus become members of the system. Selecting shop button 101 enables an existing user, such as a shopper, to shop for fundraisers and their associated e-gift cards. Selecting donate button 102 enables an existing user, such as a shopper, to search established fundraisers, towards transferring some or all of their current balance of donation dollars to one or more established fundraisers. Selecting how it works button 103 enables an existing user, such as a shopper, to view an explanatory tutorial on the general operation of the website and the present community commerce system and method.

Rotating banner region 105 enables the website operator to place a variety of promotional and informative images, text, and embedded videos on prominent display, automatically and/or manually scrolling horizontally through several separate displays. Featured fundraisers region 106 enables the website operator to place several featured fundraisers on prominent display, automatically and/or manually scrolling horizontally through several separate fundraisers. The website operator may, for example, charge an additional fee from a nonprofit or charitable institution in order to feature their fundraiser. Fundraisers ending soon region 107 enables the website operator to place several fundraisers that are due to expire shortly on prominent display, automatically and/or manually scrolling horizontally through several such fundraisers, to enable shoppers with donation dollars to potentially avail themselves of these “last chance” donating opportunities. A “see all fundraiser” button in region 107 enables the user to transition to another web page where all available fundraisers may be searched for and viewed. Most donation dollars region 108 enables the website operator to feature the e-gift cards of merchants offering the largest contributions of donation dollars per e-gift card purchase, automatically and/or manually scrolling horizontally through several separate merchant e-gift card opportunities. A “see all gift cards” button in region 108 enables the user to transition to another web page where all available gift cards may be searched for and viewed.

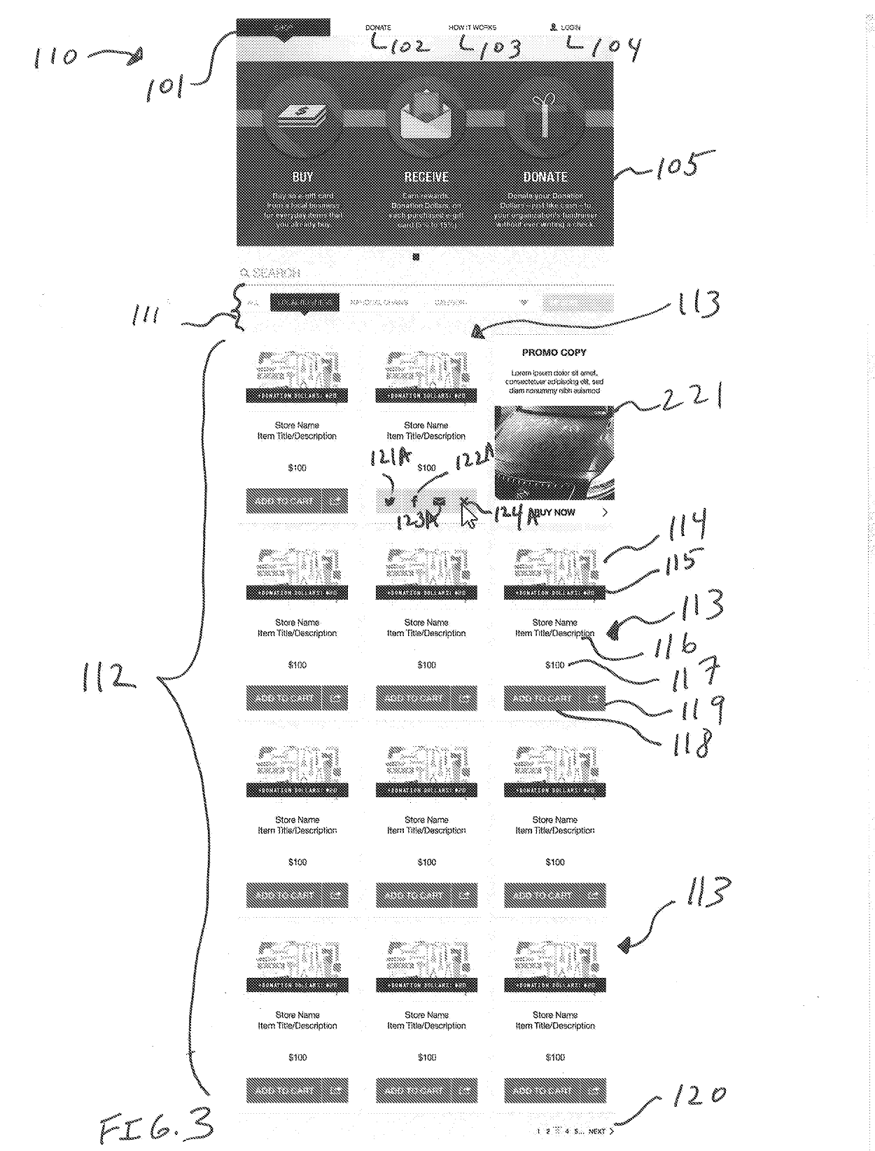

Once an established user has logged in, selecting shop button 101 causes the e-gift card shopping page 110 of FIG. 3 to appear. Referring to FIG. 3, e-gift card search region 111 enables the user to search for e-gift cards by keyword (such as business name), region, or product/service category. Within this region, a search text box enables the user to enter a merchant name or other keyword to be searched. Alternatively, or as a way of narrowing down the results of a keyword search, the buttons immediately below the search text box enable the user to select “All” (i.e., all e-gift cards), “local business”, as determined by proximity to a zip code entered by the user, or “national chains”. A “category” pull-down menu enables the user to limit the search results to specific categories of goods or services, such as “shoes” or “restaurants”. Once all of the criteria for a specific search have been entered by the user, the associated results are displayed in a grid-style view within search results region 112. Each search result, in the form of e-gift card information 113, includes a photograph or graphic 114 of the associated merchant, an indication 115 of the amount of donation dollars associated with the e-gift card, a textual description 116 of the merchant's store, the monetary initial face amount 117 of the e-gift card, a button 118 causing the e-gift card to be added to the user's virtual shopping cart, a button 119 enabling the user to share the selected e-gift card with a friend via email or by posting the e-gift card on social media. As shown in the top center e-gift card 113 of search result region 112, clicking on a button 119 causes a secondary set of buttons to replace buttons 118 and 119. Specifically, button 121A enables a reference to the particular e-gift card to be posted to a twitter account, button 122A enables a reference to the e-gift card to be posted to a Facebook account, button 123A enables a reference to the e-gift card to be emailed to a desired recipient or recipients, and button 124A cancels the e-gift card forwarding process and restores buttons 118 and 119 to visibility. In the event the number of e-gift cards in a particular search result set exceeds the available display space in search results region 112, paging controls 120 are displayed to enable the user to page back and forth among multiple pages of search results. Merchants may additionally, for a fee, have their gift cards or other promotional materials be featured in any search results, as indicated by promotional advertisement 221.

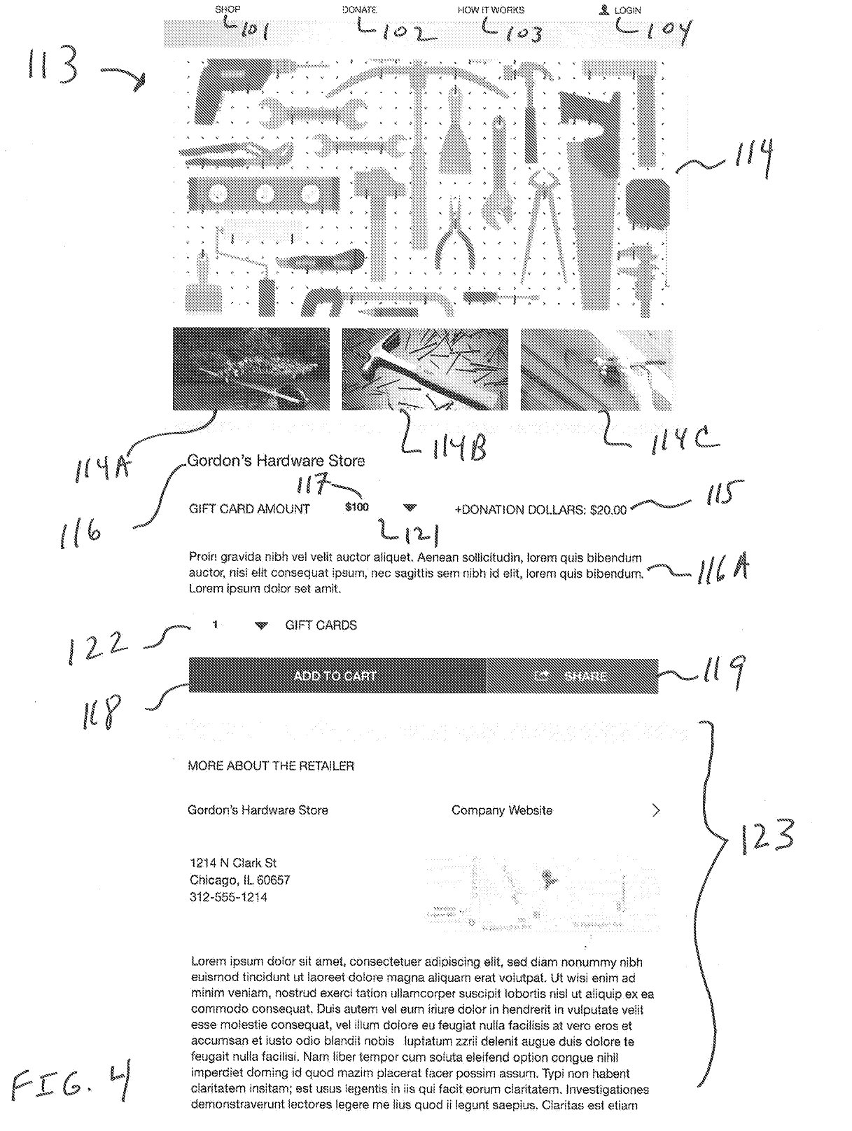

Clicking on any portion of an e-gift card 113 in search results region 112 of FIG. 3, apart from buttons 118 or 119, causes the e-gift card detail page of FIG. 4 to appear in order to provide additional details on a selected e-gift card, as well as additional details on the associated merchant. Referring to FIG. 4, additional details of a merchant and its e-gift card 113 that are displayed include a plurality of graphic and/or video images relating to the merchant, including additional images 114A, 114B, and 114C. Clicking on any specific image or video causes it to be displayed or played, as the case may be, in the largest region 114. The e-gift card initial amount 117 is displayed as an initial value in drop-down selector 121, where the user may instead elect to purchase a multiple of the original face value for the gift card (i.e., $200, $300, $400, etc. instead of $100). The associated displayed amount of donation dollars 115 will likewise be proportionately multiplied. Another drop-down selector 122 enables the user to designate a larger desired number (i.e., 2, 3, 4) of the current e-gift card 113 to be purchased. A lower region 123 of the webpage of FIG. 4 includes additional information about the merchant and its store, including its physical address, a map of its location, a link to the company website, and more textual or graphic information.

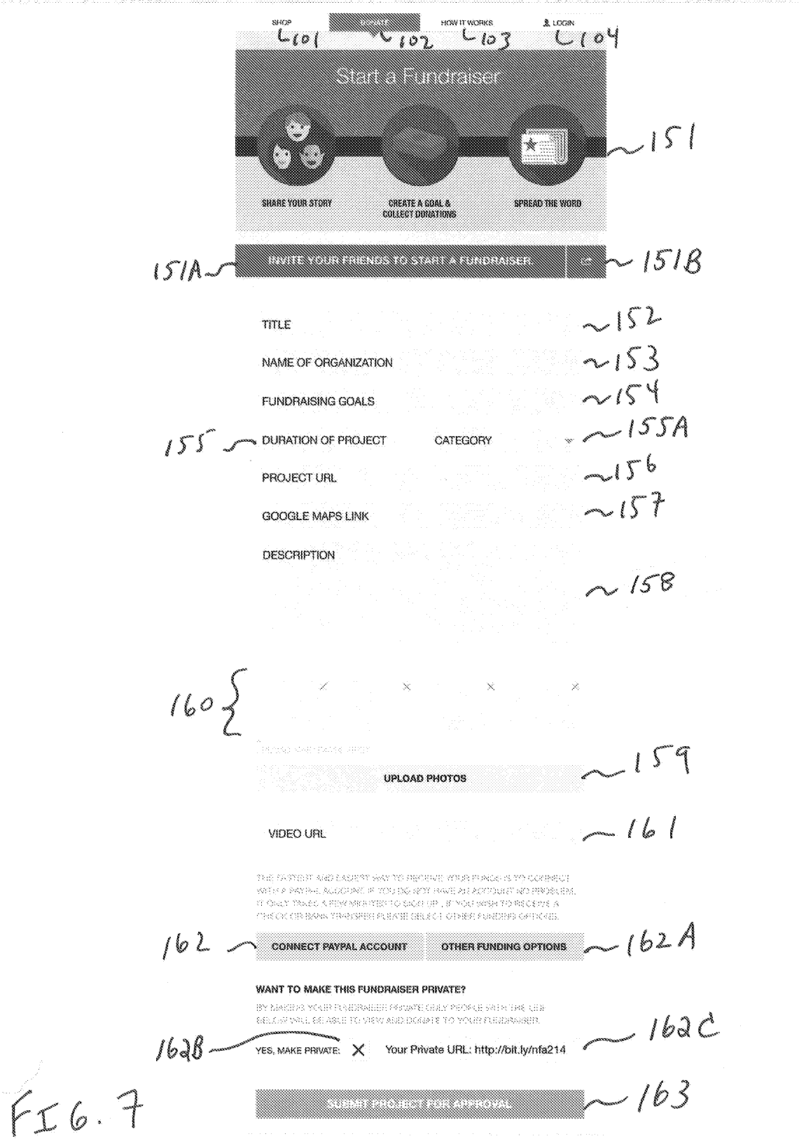

Once an established user has logged in, selecting donate button 102 causes donate/fundraiser search page 130 of FIG. 5 to appear. Referring to FIG. 5, as on home page 110, Featured fundraisers region 106 enables the website operator to place several featured fundraisers on prominent display, automatically and/or manually scrolling horizontally through several separate fundraisers. Button/region 132 encourages member shoppers to start their own fundraisers. Clicking anywhere with button/region 132 causes the fundraiser project start page of FIG. 7 to appear. With continuing reference to FIG. 5, fundraiser search region 133 enables the user to search for fundraisers by keyword (such as organization name), featured fundraisers, those ending soon, or by proximity. Within this region, a search text box enables the user to enter a nonprofit or charity name or other keyword to be searched. Alternatively, or as a way of narrowing down the results of a keyword search, the buttons immediately below the search text box enable the user to select “All” (i.e., all e-gift cards), “featured”, “ending soon”, or local fundraisers, as determined by proximity to the user's data entry within a zip code text box. A “category” pull-down menu enables the user to limit the search results to specific categories of fundraisers, such as, for example, schools, religious organizations, social welfare, and health-focused charities. Once all of the criteria for a specific search have been entered by the user, the associated results are displayed in a grid-style view within search results region 134. Each search result, in the form of fundraiser information 135, includes a photograph or graphic 136 of the associated fundraiser, an indication 137 of the remaining duration of the fundraiser, a textual description 138 of the associated project name and location, indications of the percentage 139, 139A (in the form of a vertically positionable ribbon) and amounts 140 that the project has been funded, to date, a button 141 causing transition to another web page where a specific amount of the user's current pool of donation dollars may be transferred to fund the project, and a button 142 enabling the user to share the selected project with a friend via email or by posting the project on social media, similar to the manner in which e-gift cards may be shared from e-gift card shopping page 110 of FIG. 3. In the event the number of fundraisers in a particular search result set exceeds the available display space in search results region 134, paging controls 143 are displayed to enable the user to page back and forth among multiple pages of search results.

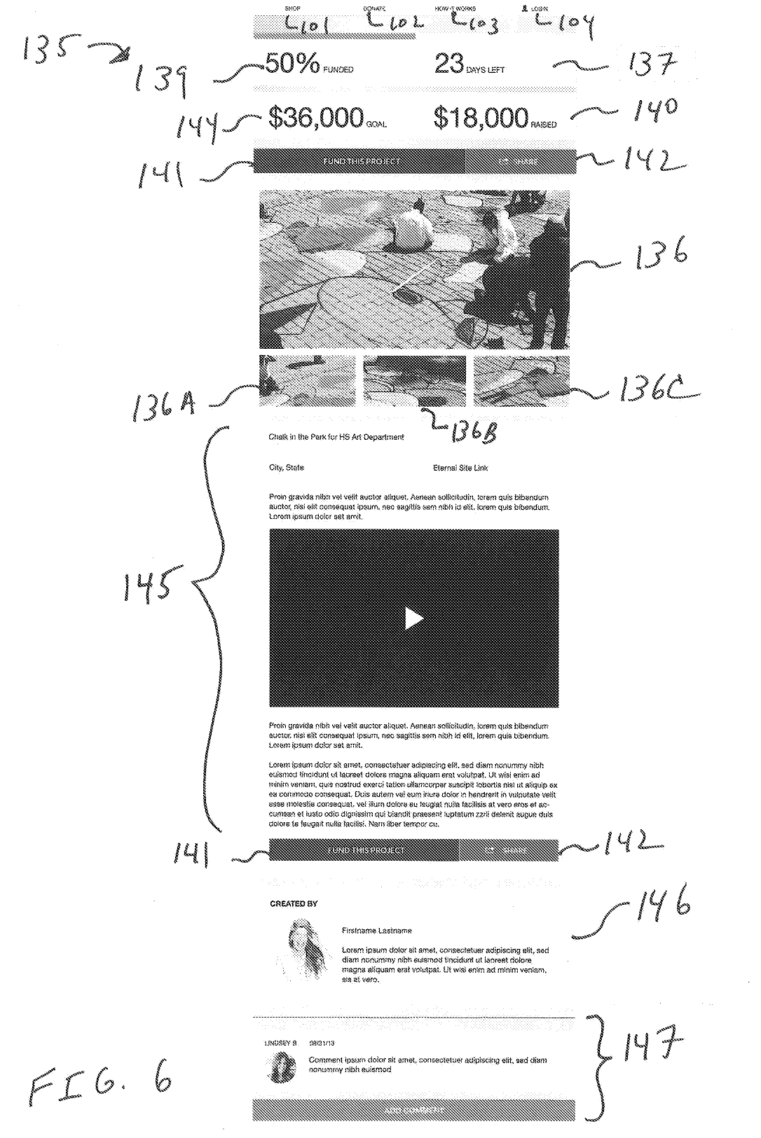

Clicking on any portion of a fundraiser 135 in search results region 134 of FIG. 5, apart from buttons 141 or 142, causes the fundraiser detail page of FIG. 6 to appear in order to provide additional details on a selected fundraiser. Referring to FIG. 6, additional details of the fundraiser that are displayed include a plurality of graphic and/or video images relating to the fundraiser, including images 136A, 136B, and 136C. Clicking on any specific image or video causes it to be displayed or played, as the case may be, in the largest region 136. As in FIG. 5, remaining fundraiser duration 137, percentage funded 139, current amount raised 140, fund buttons 141, and share buttons 142 are again displayed. In addition, fundraising goal 144, additional fundraiser information region 145, fundraiser creator information region 146, and user comment region 147 are displayed. Additional fundraiser information region 145 may include additional textual information about the current fundraiser, a link to an external website associated with the fundraiser, and an embedded video relating to the fundraiser. Fundraiser creator information region 146 may include information taken from the profile created on the present website by the creator of the fundraiser, including their name, photograph, and biographical or other text. User comment region 147 provides an opportunity for shoppers and other members of the present website to comment upon the current fundraiser, by clicking on an associated add comment button. The commenter's name, or a portion thereof, as well as a photograph previously added by the commenter to his or her profile may also be displayed along with the associated comment text.

Once an established user has logged in, selecting button 132 of the FIG. 5 causes new fundraiser project creation page 150 of FIG. 7 to appear, permitting the user to become a fundraiser creator. Referring to FIG. 7, banner region 151 permits graphics, images, or a rotating selection of graphic and images pertaining to fundraiser creation to be displayed. Button 151A is provided to prompt and enable the fundraiser creator to send a message to a friend, coworker or relative, via email, text, social media etc., inviting and encouraging them to start their own fundraiser, on behalf of either themselves or an associated organization, via the present community commerce website. Button 151B enables the fundraiser creator to share a link to the current fundraiser (once it is submitted for approval and approved by the website operator) to a friend, coworker or relative, via email, text, social media etc. A plurality of data entry text boxes permit the fundraiser creator to enter a title 152, name of organization 153, monetary fundraising goal 153, duration of project 155, a Uniform Resource Locator (“URL”) 156 associated with a webpage or website relating to the organization or the specific fundraiser, a URL 157 associated with a map showing a physical location of the organizer, and a detailed description 158 of the fundraiser and the fundraising organization. Drop-down list 155A enables the fundraiser creator to associate the fundraiser under creation one of a plurality of predetermined fundraiser categories, such as, for example, such as, for example, schools, religious organizations, social welfare, and health-focused charities. Button 159 and photo thumbnail display region 160 enable the fundraiser creator to upload a primary photograph and, optionally, additional photographs that may be employed in assisting to promote the fundraiser. Video URL text box 161 enables the fundraiser creator to specify an embedded explanatory or promotional video to be located for playback within additional fundraiser information region 145 of the fundraiser detail page of FIG. 6. connect PayPal account button 162, when pressed, launches a dialog that enables a fundraiser creator to link a specific payments and money transfer account to the fundraiser, both for payments to be made by the fundraiser creator or the associated organization to the community commerce website operator for fundraiser setup fees (if any) and fundraiser featuring fees (if any); and for the fundraiser organization to receive money transfers resulting from shopper's designation of his or her donation dollars to be given to fund the organization's fundraiser. Other funding options button 162A enables the fundraiser creator to select another method of funds transfer both to and from the community commerce website, such as, for example, identifying a personal or business checking account, by account number and bank routing number, for electronic withdrawals and deposits, respectively. Once all of the information on fundraiser creation page 150 has been entered by the fundraiser creator, button 163 is pressed to submit the fundraiser for review and approval by the community commerce website operator.

A notable feature of the present community commerce website is the ability for a fundraiser creator to designate his or her fundraiser as being “private”, meaning that, rather than being searchable and visible to all users of the website, the private fundraiser will not be included in the fundraiser ending soon display 107 of FIG. 2; the fundraiser having the most donation dollars display 108 of FIG. 2, or the fundraiser search results region 112 of FIG. 3. Private fundraisers may be particularly desirable with regard to education. For example, a student may establish a private fundraiser to establish a personal education fund, such as for college tuition, fees, and books, to cover the costs of a school trip or participation in a school sport or after-school activity, etc., in order to encourage the student's family and friends to contribute to the fund by purchasing e-gift cards and then directing their donation dollars to the student's private fundraiser.

By checking checkbox 162B of FIG. 7 during fundraiser creation, the associated fundraiser is flagged as being private in its associated database record. This, in turn, causes a unique, private URL 162, such as a short-form URL hosted by a third party service provider such as Bitly, Inc., to be generated and associated in the website's database with the private fundraiser. The fundraiser creator may then forward the private URL to the creator's friends, family, coworkers and associates, either manually, by typing the URL in an email or other communication, by using the cut-and-paste feature of the user's computer, tablet or smartphone, or via share button 151B.

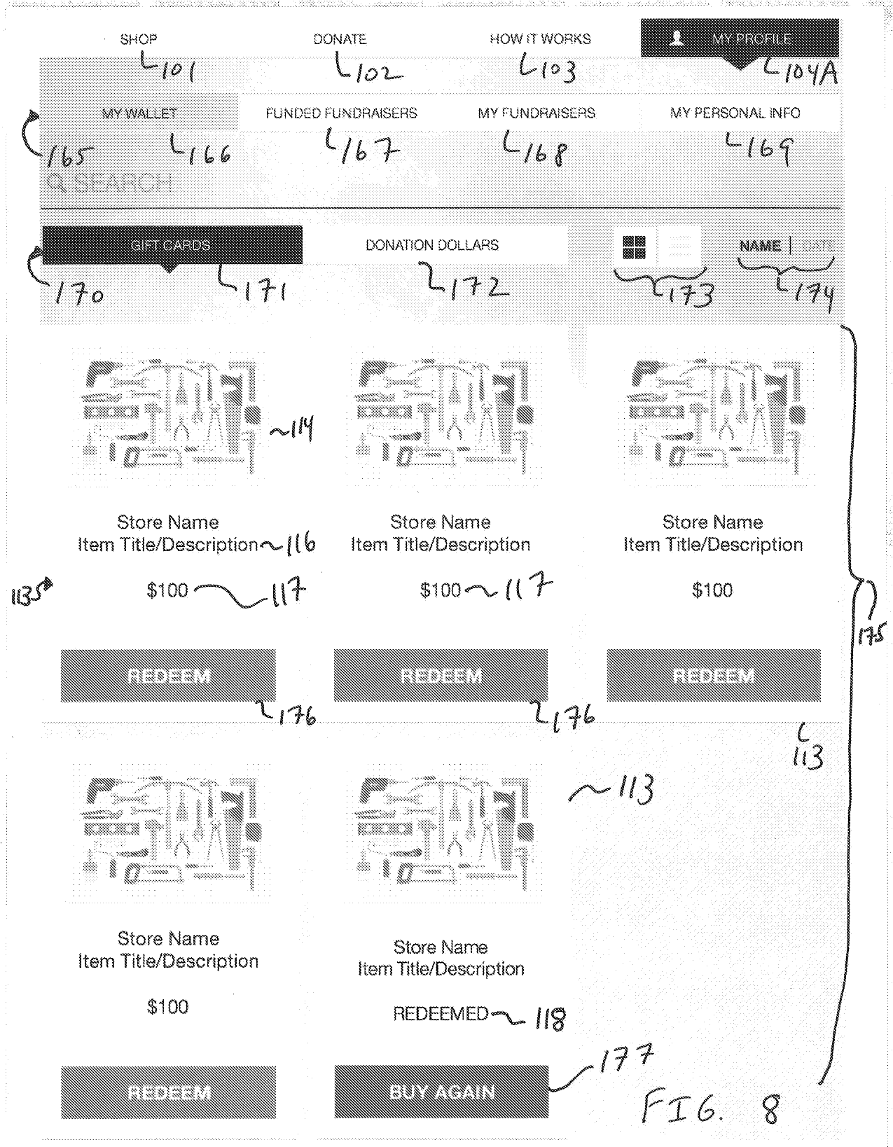

As shown in FIG. 8, once a user has logged in, login button 104 is replaced by my profile button 104A. Selecting my profile button 104A causes profile function selection bar 165, comprising my wallet button 166, funded fundraisers button 167, my fundraisers button 168, and my personal info button 169, to all become visible. As further shown in FIG. 8, selecting my wallet button 166, in turn, causes virtual wallet function selection bar 170, comprising gift cards button 171, donation dollars button 172, grid/list view selectors 173, and name/date ordering selectors 174, to all become visible. Selecting gift cards button 171, as shown in FIG. 8, causes a listing of all of the e-gift cards 113 previously purchased by the current user/shopper to be displayed within display region 175, including both e-gift cards with remaining balances, and e-gift cards that have been fully redeemed. The gift card display may be in either grid or list-style view, as determined by grid/list view selectors 173, and may displayed in either alphabetical order by store name, or in date order relative to respective dates of purchase by the user, as determined by name/date ordering selectors 174. Each displayed gift 113 includes an indication 117 of the initial monetary balance, or remaining monetary balance, on the e-gift card. For those gift cards 113 that have yet to be redeemed by the shopper, or that otherwise contain a remaining balance, an associated redeem button 176 is displayed at the bottom of the gift card. For those gift cards 113 that have already been redeemed by the shopper, an associated buy again button 177 is instead displayed at the bottom of the gift card, enabling the shopper to quickly and easily purchase additional gift cards for the same merchant.

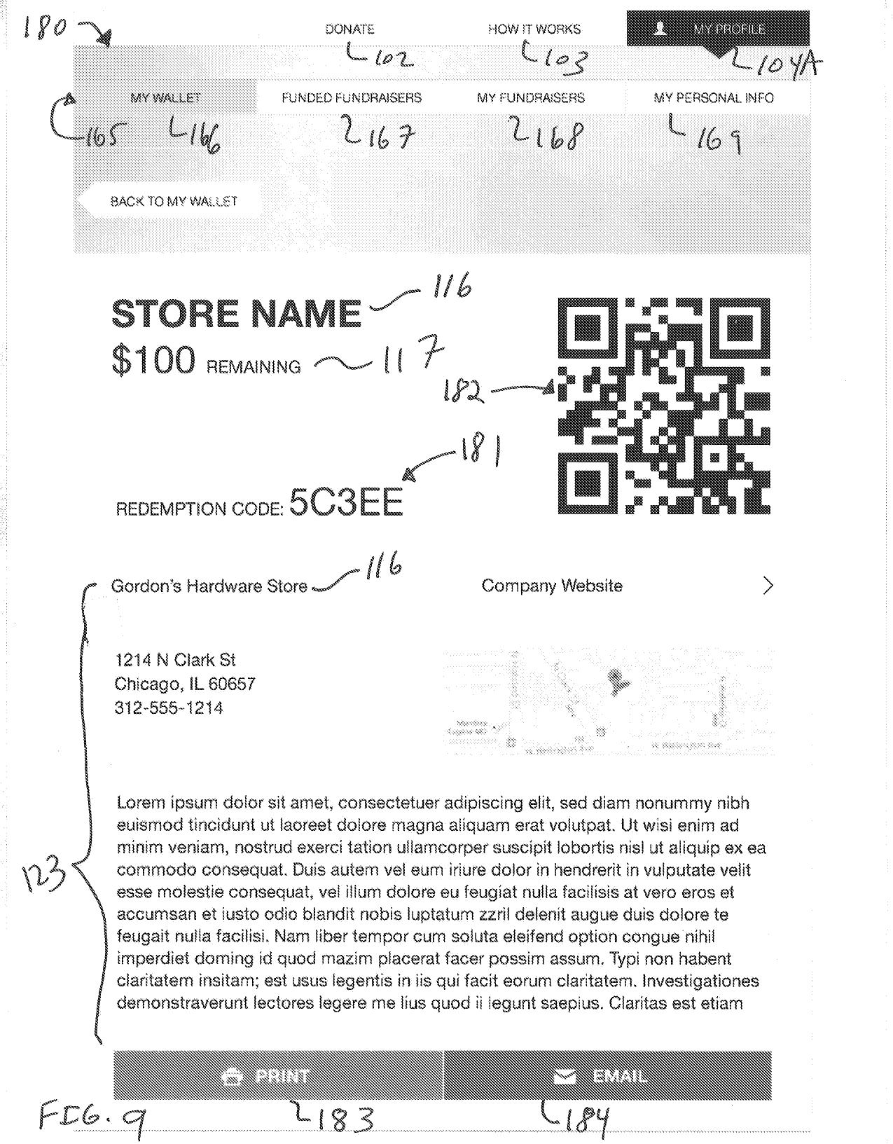

Clicking on a redeem button 177 of a gift card 113 of FIG. 8 causes e-gift card redemption page 180 of the present community commerce website to appear, as shown in FIG. 9. As in the e-gift card detail page of FIG. 4, a textual description 116 of the associated store, the monetary remaining balance on the gift card 117, .and a lower region 123 including additional information about the merchant and its store, including its physical address, a map of its location, a link to the company website, and more textual or graphic information. In addition, a redemption code is displayed in both textual and barcoded formats, such as 5-character alphanumeric redemption code 181 is displayed, together with 2-D or Quick Response (QR) redemption barcode 181. 5-digit alphanumeric redemption code 181 may be manually entered at a merchant's point-of-sale terminal in order to use the e-gift card to purchase goods or merchandise at an associated store. Moreover, 5-digit alphanumeric redemption code 181 may be manually entered by a shopper on a suitable online checkout or order placement webpage of a merchant in order to use the e-gift card to purchase goods or services at an online store of the merchant. Alternatively, 2-D QR redemption barcode 181 may be scanned by a merchant using a scanner coupled to a point-of-sale terminal as a part of the checkout process, either by scanning the barcode image directly from a tablet or smartphone of the shopper displaying e-gift card webpage 180, or by the shopper employing print button 183 to print a hardcopy of e-gift card webpage 180 which may be presented at the merchant's store for redemption barcode scanning. Button 184 enables the shopper to email a copy of the current e-gift card to another system where printing may be more convenient.

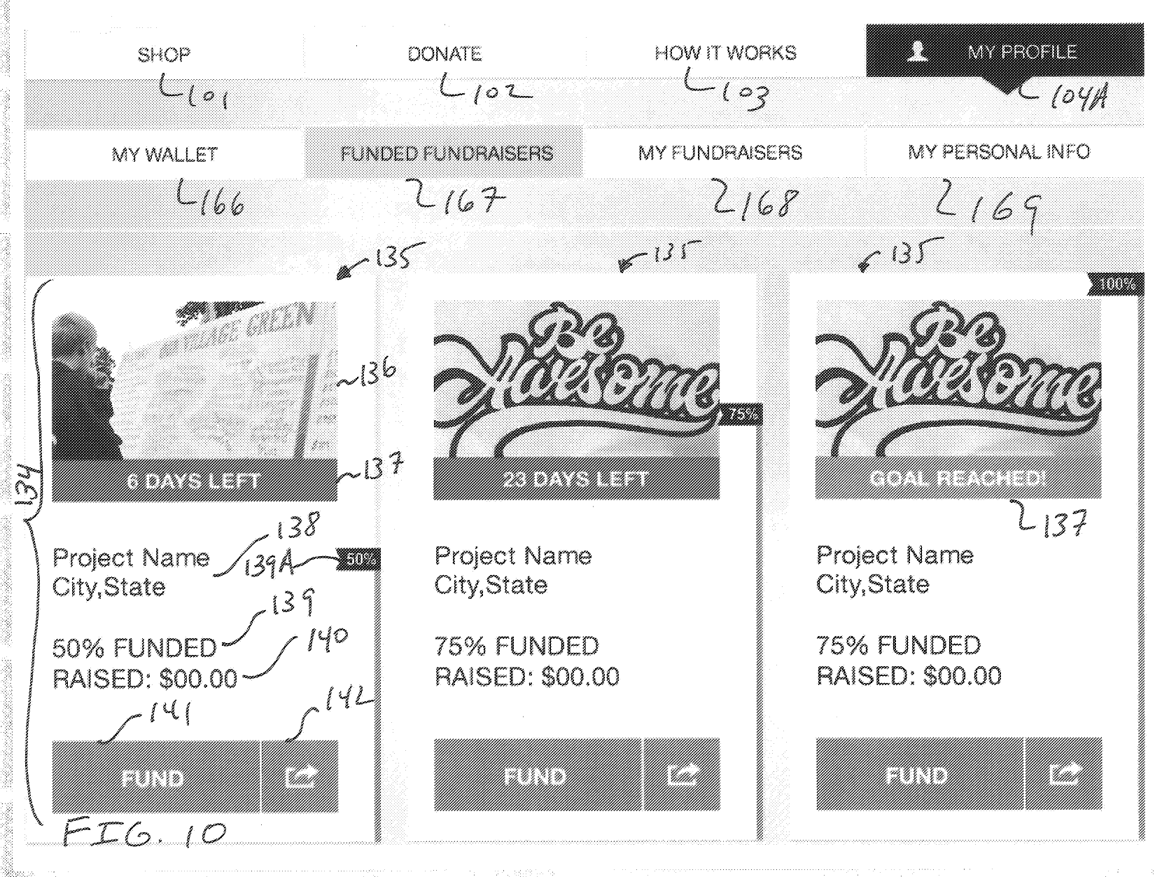

As shown in FIG. 10, once a user has logged in, selecting my profile button 104A causes profile function selection bar 165, comprising my wallet button 166, funded fundraisers button 167, my fundraisers button 168, and my personal info button 169, to all become visible. As further shown in FIG. 10, selecting funded fundraisers button 167, in turn, causes a listing of all of the fundraisers 135 previously funded by the current user/shopper to be displayed within display region 134. Each funded fundraiser 135, includes a photograph or graphic 136 of the associated fundraiser, an indication 137 of the remaining duration of the fundraiser, a textual description 138 of the associated project name and location, indications of the percentage 139, 139A (in the form of a vertically positionable ribbon) and amounts 140 that the project has been funded, to date, a button 141 enabling the user/funder to transfer additional amounts of the user's current pool of donation dollars to further fund the project, and a button 142 enabling the user/funder to share the selected project with a friend via email or by posting the project on social media, similar to the manner in which e-gift cards may be shared from e-gift card shopping page 110 of FIG. 3.

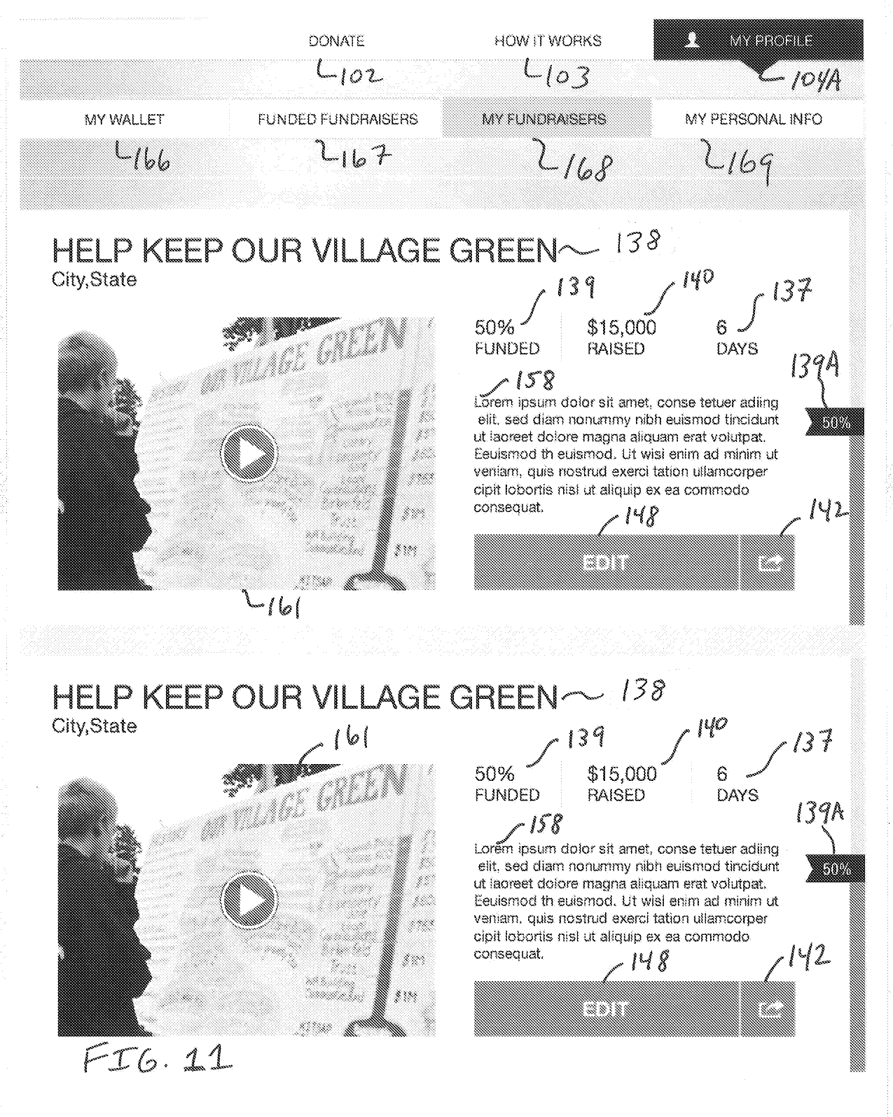

As shown in FIG. 11, once a user has logged in, selecting my profile button 104A causes profile function selection bar 165, comprising my wallet button 166, funded fundraisers button 167, my fundraisers button 168, and my personal info button 169, to all become visible. As further shown in FIG. 11, selecting my fundraisers button 168, in turn, causes a listing of all of the fundraisers previously created by the current user to be displayed within a display immediately below. Each created fundraiser is shown in FIG. 11 as comprising a textual description 138 of the associated project name and location, indications of the percentage 139, 139A (in the form of a vertically positionable ribbon) and amounts 140 that the project has been funded, to date, a detailed description 158 of the fundraiser and the fundraising organization, a button 148, enabling the fundraiser creator to edit the settings of the current fundraiser, and another button 142 enabling the user to share the selected project with a friend via email or by posting the project on social media, similar to the manner in which e-gift cards may be shared from e-gift card shopping page 110 of FIG. 3.

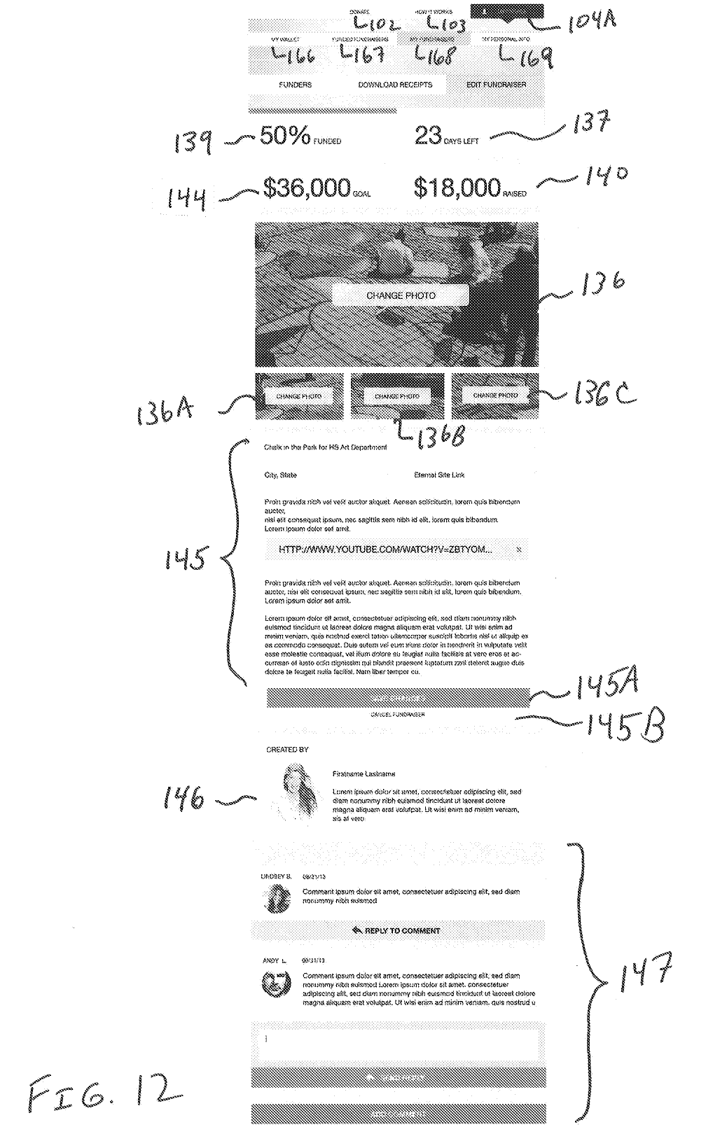

Clicking on and edit button 148 of any of the user/creator's fundraisers of FIG. 11 causes the edit fundraiser webpage of FIG. 12 to be displayed. As shown in FIG. 12, the edit fundraiser webpage comprises include a plurality of photographic images relating to the fundraiser, including images 137, 136A, 136B, and 136C. Clicking on any specific image causes a change photo dialog to be displayed, enabling the fundraiser creator to upload a different, replacement photograph. As in FIG. 5, remaining fundraiser duration 137 (in editable fashion), percentage funded 139, and the current amount raised 140 are again displayed. In addition, fundraising goal 144 (in editable fashion), additional fundraiser information region 145 (in editable fashion), fundraiser creator information region 146, and user comment region 147 are displayed. Button 145A enables the fundraiser creator to save edited changes to the current fundraiser, and cancel fundraiser button 145B enables the fundraiser creator to terminate the current fundraiser. User comment region 147 provides an opportunity for the fundraiser creator to reply to specific comments associated with the current fundraiser, left by other users of the present community commerce website, and to add their own comments in association with the current fundraiser.

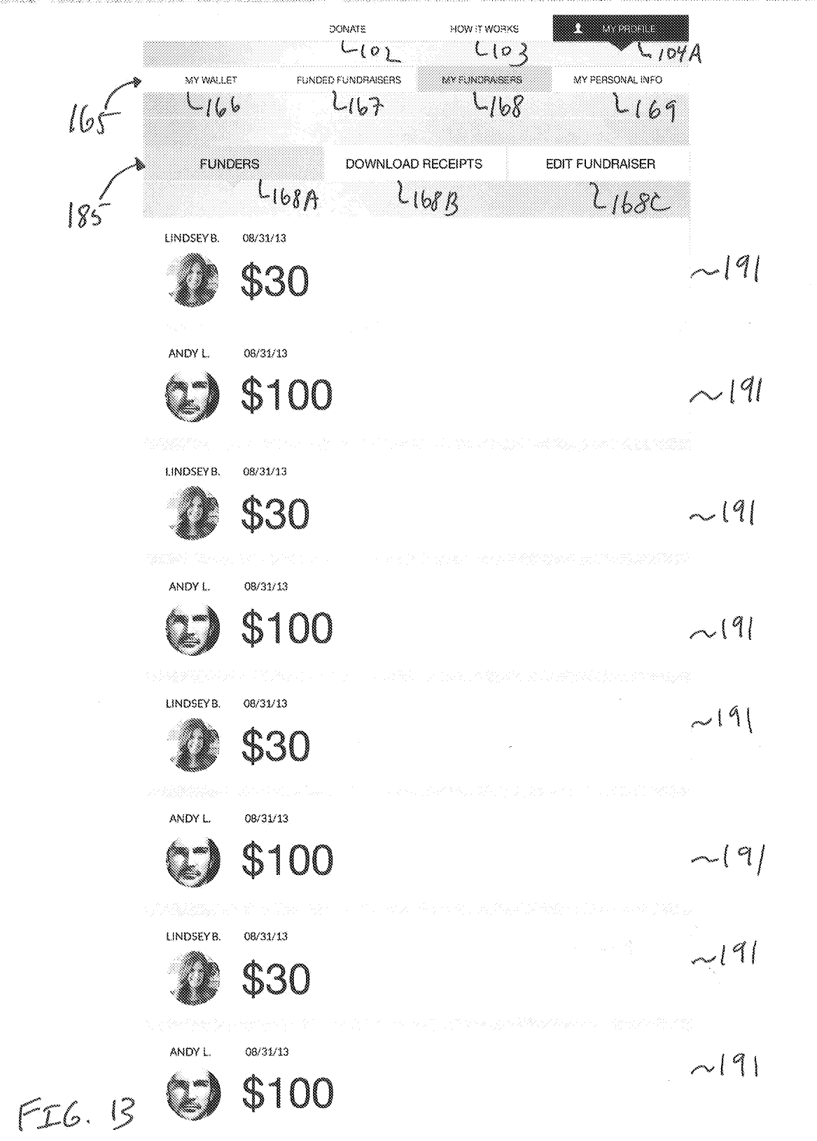

As shown in FIG. 13, once a user has logged in, login button 104 is replaced by my profile button 104A. Selecting my profile button 104A causes profile function selection bar 165, comprising my wallet button 166, funded fundraisers button 167, my fundraisers button 168, and my personal info button 169, to all become visible. As further shown in FIG. 13, selecting my fundraisers button 168, in turn, causes my fundraisers function selection bar 185, funders button 168A, download receipts button 168B, and edit fundraisers 168C to all become visible. Selecting funders button 168A, as shown in FIG. 13, causes a listing of all of the individual shoppers/members 191 of the present community commerce website that have previously funded any fundraiser created by the current user. The information displayed in association with each funder 191 includes the funder's name (or, if partial anonymity is desired, the funder's first name and first letter of the funder's surname), date(s) of contribution, and amount(s) of contribution.

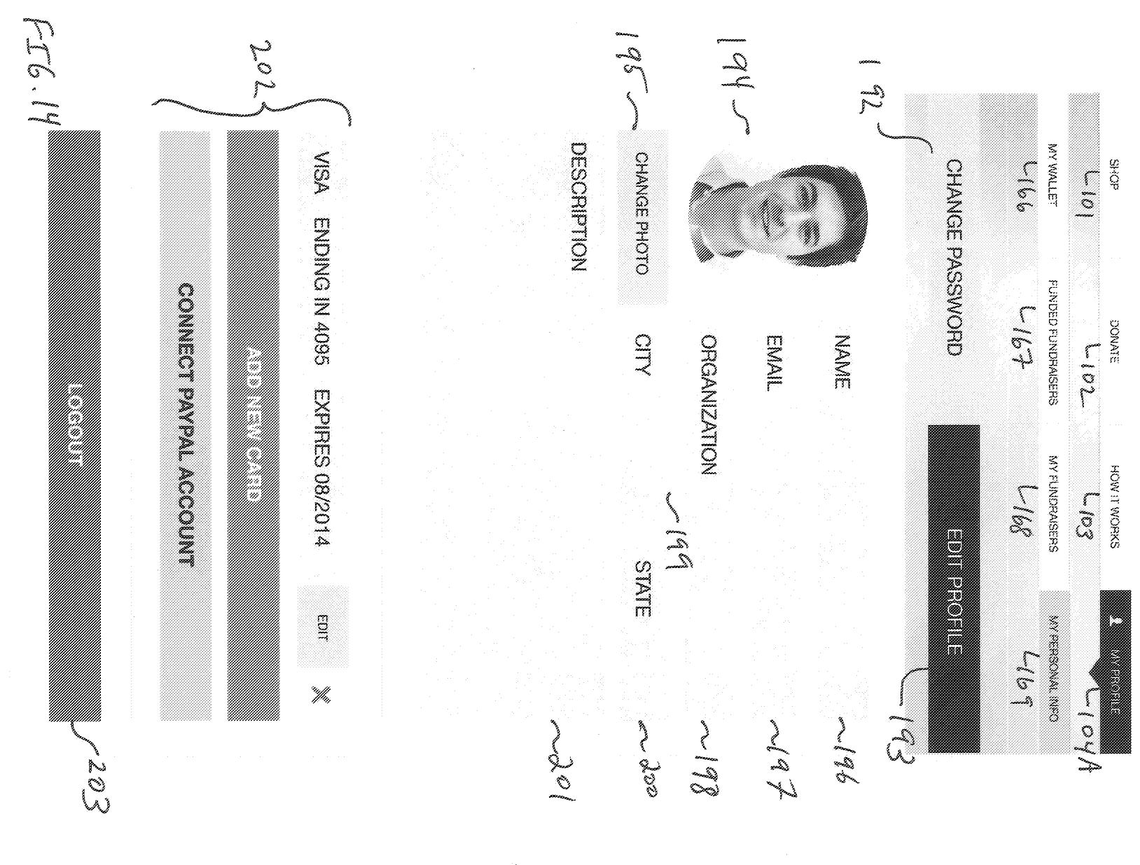

As shown in FIG. 14, a logged-in user's selection of profile button 104A causes profile function selection bar 165, comprising my wallet button 166, funded fundraisers button 167, my fundraisers button 168, and my personal info button 169, to all become visible. As further shown in FIG. 14, selecting my personal info button 169, in turn, causes elements of a profile view/edit webpage to become visible. In particular, the profile editing webpage includes password change button 192, edit profile button 193, profile photo 194 and profile photo change button 195, name text box 196, email address text box 197, organization text box 198, city and state text boxes 199, 200, and description text box 201, enabling the user to enter biographical or other relevant information about themselves. Clicking on edit profile 193 enables editing of what are otherwise display-only text boxes 196 through 201, and likewise enables change photo change button 195. With further reference to FIG. 14, credit card and money transfer account region 202 enables the user to specify one or more credit cards and/or money transfer accounts, for use, for example, in the payment of fees for establishing merchant accounts or becoming a featured fundraiser or merchant. Logout button 203 enables the current user to log out of the present community commerce website.

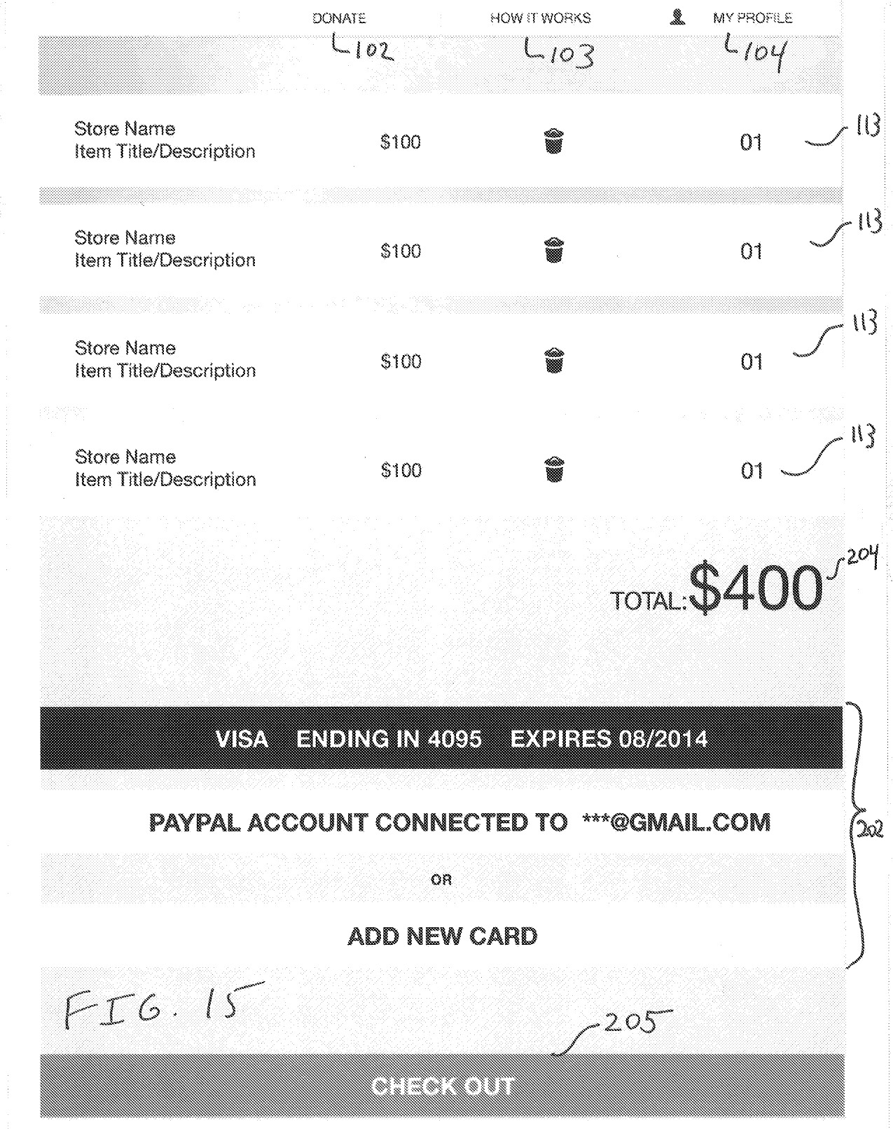

Clicking on the e-commerce shopping cart icon on the home page or other webpage of the present community commerce website causes the shopping cart webpage of FIG. 15 to be displayed. As shown in FIG. 15, the shopping card includes a listing of all e-gift cards 113 that the shopper has selected for purchase. Each e-gift card 113 includes a textual identification of the merchant and the nature of the e-gift card, the purchase price (and, typically, the initial value of the gift card), and icon that, when selected, enables the e-gift card to be deleted from the shopping cart, and the quantity of the specific e-gift card 113 selected for purchase. A total 204 of the amount to be paid to purchase all of the e-gift cards 113 is displayed, as is a region 202 enabling the shopper to select a previously identified credit card or money transfer account, or to add a new credit card at this time. Checkout button 205 enables the shopper to complete the purchase of all of the e-gift cards in the e-commerce shopping cart of FIG. 15.

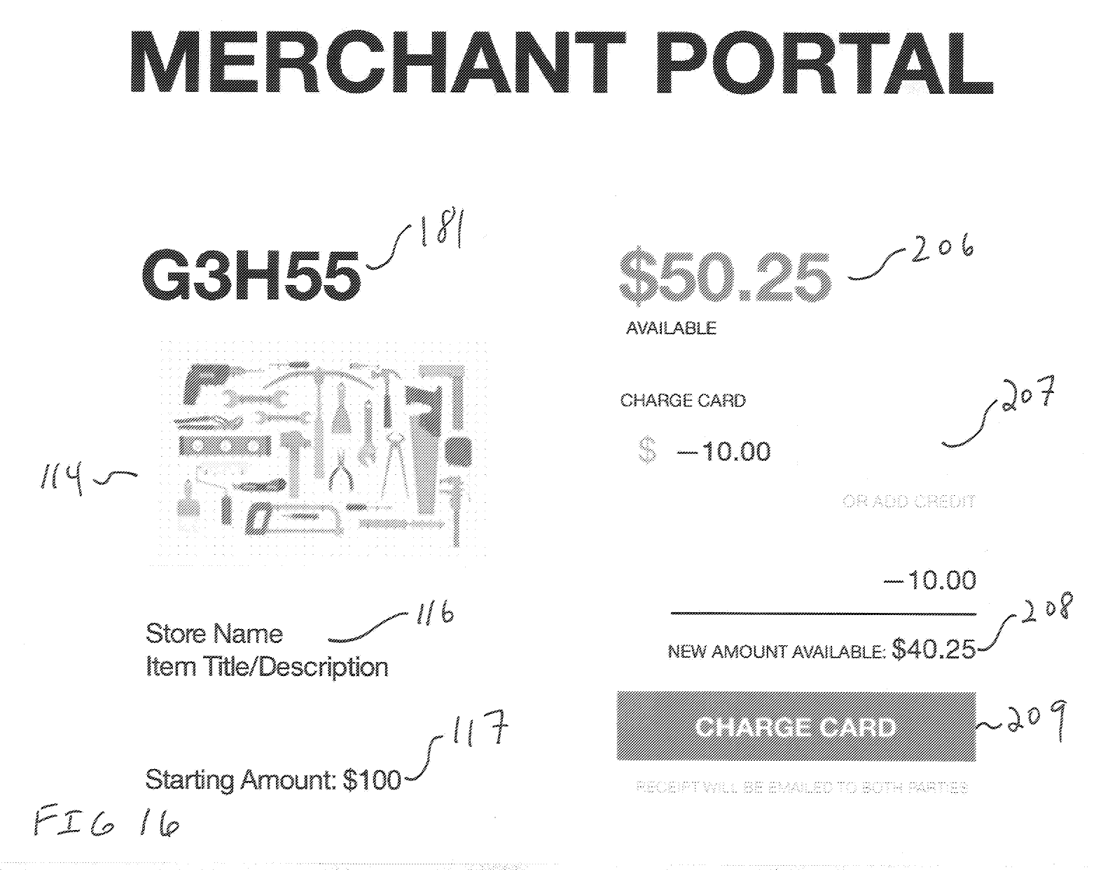

At a point of purchase, such as a brick-and-mortar store for which an associated e-gift card has been issued, a merchant may employ a point-of-sale terminal to log into the present community commerce website via an associated merchant portal function. As shown in FIG. 16, scanning the barcode or manually entering a redemption code for an e-gift card presented by a shopper causes the e-gift card transaction webpage of FIG. 16 to be displayed. As shown in FIG. 16, the information displayed on this webpage includes the scanned or manually entered redemption code 181 serving to identify the e-gift card, a graphical image 114 associated with the e-gift card, the store name and description 116, the initial amount of funds 117 when the gift card was initially issued, the current available balance 206 on the e-gift card, the amount 207 to be charged against the e-gift card for goods or services, the new remaining balance 208, and a button 209 to complete the transaction and charge the purchase to the displayed e-gift card. The remaining balance of the e-gift card is also reflected on the community commerce website, within the user's virtual wallet, as discussed below.

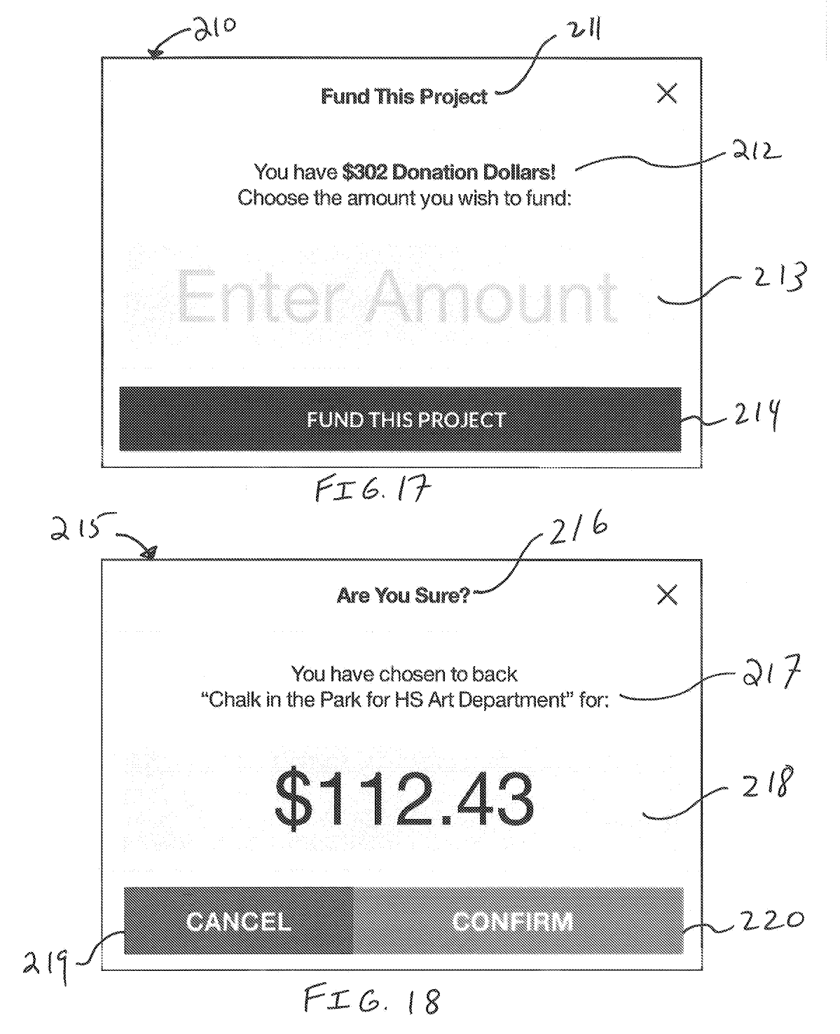

Clicking on a “fund” or “fund this project” button 141 associated with a displayed fundraiser on any of FIGS. 2, 5, 6, and 10 causes popup dialog 210 of FIG. 17 to be displayed. Popup dialog 210 comprises text 211 identifying the function of the dialog, a display 212 of the logged-in user's current balance of available donation dollars, a text entry box 213 enabling the user to identify an amount of donation dollars to be transferred to the project, and a button 214 to be pressed by the user after entering a numerical amount in text box 213. Clicking on button 214 causes popup dialog 210 to be replaced with another popup dialog 215 of FIG. 18 to enable the user to confirm or cancel the donation. Popup dialog 215 comprises prompt message 216, text 217 identifying the project to be funded, an identification 218 of the amount of the user's donation dollars to be transferred to the project, a button 219 enabling the user to cancel the transaction, and another button 220 enabling the user to confirm that the transaction should proceed.

It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

What is claimed is:

1. A method of fundraising for a charitable or nonprofit organization, comprising:
permitting a plurality of merchants to establish e-gift cards for sale on a website, each of the gift cards having a face value and a donation value;
facilitating the purchase of e-gift cards by users of the website;
transferring funds to the merchant upon a user's purchase of an e-gift card established by the merchant, the funds having a value of the face value of the gift card less the donation amount;
adding the donation amount to a donation dollars account maintained on behalf of the user;
permitting a plurality of charitable or nonprofit organizations to establish fundraising projects on the website;
permitting a user to allocate some or all of the user's donation dollars account to a selected fundraising project; and
transferring funds to the charitable or nonprofit organization associated with the selected fundraising project in an amount allocated by the user.
